(19) United States
(12) Patent Application Publication
(10) Pub. No.: US 2019/0353777 A1
(43) Pub. Date: Nov. 21, 2019

(54) Passive, Walk-Through Metal Detection System

(71) Applicant: Rapiscan Systems, Inc., Torrance, CA (US)

(72) Inventor: Edward James Morton, Guildford (GB)

(21) Appl. No.: 16/520,690

(22) Filed: Jul. 24, 2019

Related U.S. Application Data
(63) Continuation-in-part of application No. 15/859,777, filed on Jan. 2, 2018.
Application No. 15/859,777 is a continuation of application No. 14/639,956, filed on Mar. 5, 2015, now Pat. No. 9,891,314.
(60) Provisional application No. 62/702,868, filed on Jul. 24, 2018.
(60) Provisional application No. 62/702,841, filed on Jul. 24, 2018.
(60) Provisional application No. 62/702,833, filed on Jul. 24, 2018.
(60) Provisional application No. 61/949,775, filed on Mar. 7, 2014.

(51) Int. Cl. G01S 13/88; G01S 13/87; G01V 8/00; G01S 13/02

(52) U.S. Cl. CPC G01S 13/887; G01S 13/0209; G01V 8/005; G01S 13/87

(57) ABSTRACT

A portal for scanning a person walking through a surveillance volume defined by the portal, wherein the surveillance volume is illuminated by a magnetic field, and wherein the person is carrying at least one object on the person's body, the portal having a plurality of magnetic sensor modules arranged in at least one array and positioned on at least one of first and second opposing sides of the portal, wherein the plurality of magnetic sensor modules measure perturbations in the magnetic field caused by the at least one object in the surveillance volume, and wherein each of the magnetic sensor modules includes first, second and third magnetometers configured in substantially three orthogonal directions; and a processor associated with the plurality of magnetic sensor modules to process the measured perturbations to determine a location and magnetic signature of the at least one object.

### CROSS-REFERENCE

The present application relies on U.S. Patent Provisional Application No. 62/702,833, entitled “Passive, Walk-Through Metal Detection System” and filed on Jul. 24, 2018, for priority.

The present application also relies on U.S. Patent Provisional Application No. 62/702,841 entitled “Radar-Based Inspection System” and filed on Jul. 24, 2018, for priority.

The present application also relies on U.S. Patent Provisional Application No. 62/702,868 entitled “Radar-Based Baggage and Parcel Inspection Systems” and filed on Jul. 24, 2018, for priority.

The present specification is also a continuation-in-part application of U.S. patent application Ser. No. 15/859,777, entitled “Ultra Wide Band Detectors”, filed on Jan. 2, 2018, which in turn, is a continuation application of U.S. patent application Ser. No. 14/639,956, entitled “Ultra Wide Band Detectors”, filed on Mar. 5, 2015, and issued as U.S. patent application Ser. No. 9,891,314 on Feb. 13, 2018, which, in turn, relies on U.S. Patent Provisional No. 61/949,775, entitled “Ultra-Wide Band Detectors”, and filed on Mar. 7, 2014, for priority.

The present application relates to U.S. patent application Ser. No. 15/625,925, entitled “Detector Systems”, filed on Jun. 16, 2017, and issued as U.S. Pat. No. 10,107,783 on Oct. 23, 2018, which is a continuation application of U.S. patent application Ser. No. 14/020,317, of the same title, filed on Sep. 6, 2013, and issued as U.S. Pat. No. 9,714,920 on Jul. 25, 2017, which is a continuation application of U.S. patent application Ser. No. 12/523,051, of the same title, filed on Jul. 13, 2009, and issued as U.S. Pat. No. 8,552,722 on Oct. 8, 2013, which is a national stage application of PCT Application No. PCT/GB2008/000116, filed on Jan. 15, 2008, which relies on Great Britain Patent Application Number 0703481.2, filed on Feb. 22, 2007 and Great Britain Patent Application Number 0700731.3, filed on Jan. 15, 2007, for priority.

All of the above-mentioned patents and patent applications are herein incorporated by reference in their entirety.

### FIELD

The present application relates to electromagnetic (EM) inspection/detection systems. More particularly, the present application relates to a passive walk through portal system for locating and characterizing a metal or ferrous object located on a person.

### BACKGROUND

In recent years, screening for weapons at entrances of public places, such as airports, government buildings, public schools, and amusement parks, has increased to ensure safety for the public at these locations. Screening for weapons can include requiring people entering such public places to pass through a magnetic screening system such as a portal metal detector that comprise a surveillance zone defined by a walk-through archway or portal within which magnetic fields are monitored. A characteristic magnetic field within the surveillance zone is indicative of the presence of a metal object within said area.

Active metal detectors transmit a primary, time-dependent magnetic field within the surveillance zone and measure secondary magnetic fields arising from eddy currents induced in any metal object within a zone of influence of the primary magnetic field. Active metal detectors fall broadly into two categories; namely pulse-induction detectors which utilize a transient magnetic field, and continuous wave detectors which use an alternating (sinusoidal) magnetic field. Active detectors can be dangerous for people using medical devices, such as pacemakers, that are sensitive to electro-magnetic fields.

At their simplest, security metal detectors merely provide an indication of the absence or presence of a metal object within the surveillance zone by comparing the magnitude of the measured magnetic field against a threshold that is predetermined by the user. In the event that a metal object is detected, the person being screened may have to undergo a thorough manual search in order to determine the location of the metal object on the person.

More sophisticated security metal detectors are capable of providing an approximate indication of the location of a metal object within the surveillance zone. However, there is an increasing requirement for security metal detectors to be able to provide some form of discrimination between threat items (knives, guns etc.) and non-threat items such as personal electronic devices.

Therefore, what is needed is a passive metal detection system that is capable of characterizing and locating the position of hidden ferrous objects. There is also a need for a new generation of electromagnetic screening equipment that combines low false threat alarm with high rate of screening without being unsafe for people using medical devices, such as pacemakers, that are sensitive to electro-magnetic fields.

### SUMMARY

The following embodiments and aspects thereof are described and illustrated in conjunction with systems, tools and methods, which are meant to be exemplary and illustrative, and not limiting in scope. The present application discloses numerous embodiments.

The present specification discloses a portal for scanning a person walking through a surveillance volume defined by said portal, wherein the surveillance volume is illuminated by a magnetic field, and wherein the person is carrying at least one object on the person's body, the portal comprising: a plurality of magnetic sensor modules arranged in at least one array and positioned on at least one of first and second opposing sides of the portal, wherein said plurality of magnetic sensor modules measure perturbations in the magnetic field caused by said at least one object in the surveillance volume, and wherein each of said magnetic sensor modules includes first, second and third magnetometers configured in substantially three orthogonal directions; and a processor associated with said plurality of magnetic sensor modules to process said measured perturbations to determine a location and magnetic signature of said at least one object.

Optionally, said magnetic field is earth's magnetic field.

Optionally, a first array is positioned on said first side and a second array is positioned on said second side. Each of said first and second arrays may include four magnetic sensor modules.

Optionally, a first and a second array is positioned on said first side and a third and a fourth array is positioned on said second side. Each of said first, second, third, and fourth arrays may include four magnetic sensor modules. The first and second arrays may be staggered vertically by a predefined distance. The third and fourth arrays may also be staggered vertically by a predefined distance. The predefined distance may be equal to half of a distance between each magnetic sensor module within the arrays. Optionally, said first and second array on said first panel are offset by a predetermined distance in a horizontal or walkthrough direction with respect to said third and fourth arrays on said second panel.

Optionally, said measured perturbations represent a gradient of the magnetic field in each of said substantially three orthogonal directions.

Optionally, each of said first, second and third magnetometers are single-axis magnetometers.

Optionally, each of said plurality of magnetic sensor modules includes a substantially L-shaped flexible circuit board when flat, said circuit board defining a first region to carry the first magnetometer, a second region to carry the second magnetometer and a third region to carry the third magnetometer, wherein folding of said circuit board arranges said magnetometers in substantially three orthogonal directions.

Optionally, each of said plurality of magnetic sensor modules has an associated Digital Signal Processor (DSP) to acquire and condition said perturbations of the magnetic field.

Optionally, said magnetic signature is a magnetic polarizability tensor of said at least one object.

The present specification also discloses a method for scanning a person walking through a surveillance volume defined by a portal, wherein the surveillance volume is illuminated by a magnetic field, and wherein the person is carrying at least one object on the person's body, the method comprising: using a plurality of magnetic sensor modules to measure perturbations in the magnetic field caused by said at least one object in the surveillance volume, wherein said plurality of magnetic sensor modules are arranged in at least one array and positioned on at least one of first and second opposing sides of the portal, and wherein each of said magnetic sensor modules includes first, second and third magnetometers configured in substantially three orthogonal directions; and processing said measured perturbations to determine a location and magnetic signature of said at least one object.

Optionally, said magnetic field is earth's magnetic field.

Optionally, a first array is positioned on said first side and a second array is positioned on said second side. The first and second arrays may include four magnetic sensor modules.

Optionally, said measured perturbations represent a gradient of the magnetic field in each of said substantially three orthogonal directions.

Optionally, each of said first, second and third magnetometers are single-axis magnetometers.

Optionally, each of said plurality of magnetic sensor modules includes a substantially L-shaped flexible circuit board when flat, said circuit board defining a first region to carry the first magnetometer, a second region to carry the second magnetometer and a third region to carry the third magnetometer, wherein folding of said circuit board arranges said magnetometers in substantially three orthogonal directions.

Optionally, each of said plurality of magnetic sensor modules has an associated DSP to acquire and condition said perturbations of the magnetic field.

Optionally, said magnetic signature is a magnetic polarizability tensor of said at least one object.

The present specification also discloses a portal for scanning a person walking through a surveillance volume defined by said portal, wherein the surveillance volume is illuminated by a magnetic field, and wherein the person is carrying at least one object on the person's body, the portal comprising: a plurality of magnetic sensor modules arranged in at least one array and positioned on at least one of first and second opposing sides of the portal, wherein said plurality of magnetic sensor modules measure perturbations in the magnetic field caused by said at least one object in the surveillance volume, wherein each of said magnetic sensor modules includes a flexible circuit board defining a first region to carry a first magnetometer, a second region to carry a second magnetometer and a third region to carry a third magnetometer, said circuit board being substantially L-shaped when flat, and wherein folding of said circuit board arranges said first, second and third magnetometers in substantially three orthogonal directions; and a processor associated with said plurality of magnetic sensor modules to process said measured perturbations to determine a location and magnetic signature of said at least one object.

Optionally, said magnetic signature is a magnetic polarizability tensor of said at least one object.

The aforementioned and other embodiments of the present specification shall be described in greater depth in the drawings and detailed description provided below.

### BRIEF DESCRIPTION OF THE DRAWINGS

These and other features and advantages of the present specification will be further appreciated, as they become better understood by reference to the following detailed description when considered in connection with the accompanying drawings:

FIG. 1A is a schematic diagram of a detection system, in accordance with an embodiment of the present specification;

FIG. 1B illustrates a plurality of magnetic field sensor modules arranged in the form of at least one array on each of two opposing sides of a support frame, in accordance with an embodiment of the present specification;

FIG. 1C illustrates a plurality of magnetic field sensor modules arranged in the form of at least one array on one of two opposing sides of a support frame, in accordance with an embodiment of the present specification;

FIG. 1D is a plan view of a first panel and a second panel, each having two arrays of magnetic field sensor modules where each array is staggered in a vertical direction, in accordance with an embodiment of the present specification;

FIG. 1E is a sectional top view of the first and second panels of FIG. 1D showing at least one array of the first panel offset by a horizontal distance, in a walkthrough direction, with respect to at least one array on the second panel, in accordance with an embodiment of the present specification;

FIG. 2A illustrates a plurality of magnetic sensor modules arranged in an array in accordance with an embodiment of the present specification;

FIG. 2B is a block diagram illustration of an individual magnetic sensor module of a flexible electronic circuit board, in a flat or unfolded configuration in accordance with an embodiment of the present specification;

FIG. 3 is a flow chart illustrating a plurality of steps of an embodiment of a method of detection, localization and characterization of a ferrous object carried by a person walking through a surveillance volume of the detection system of the present specification; and,

FIG. 4 illustrates an exemplary visual output of the detection system, in accordance with an embodiment of the present specification.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “comprise” “include” and “have”, and forms thereof, are not necessarily limited to members in a list with which the words may be associated. It should be noted herein that any feature or component described in association with a specific embodiment may be used and implemented with any other embodiment unless clearly indicated otherwise.

As used herein, the indefinite articles “a” and “an” mean “at least one” or “one or more” unless the context clearly dictates otherwise.

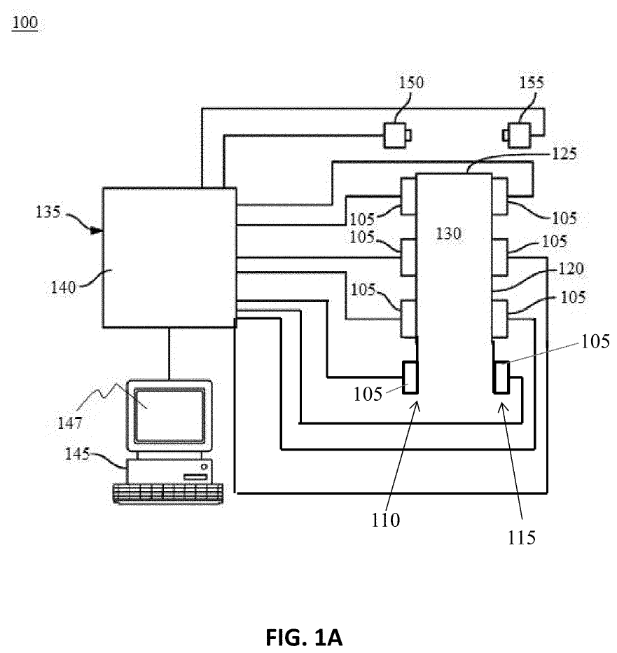

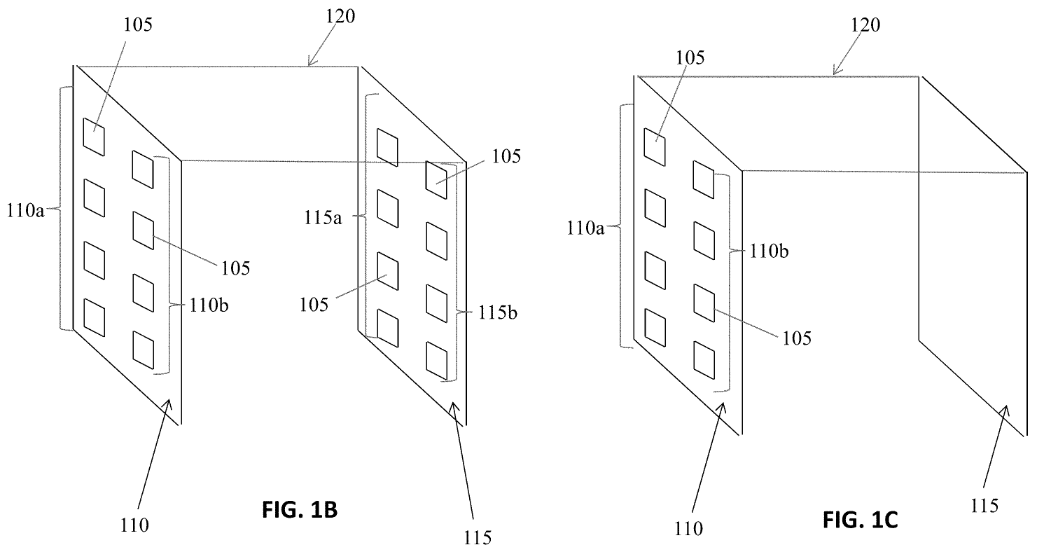

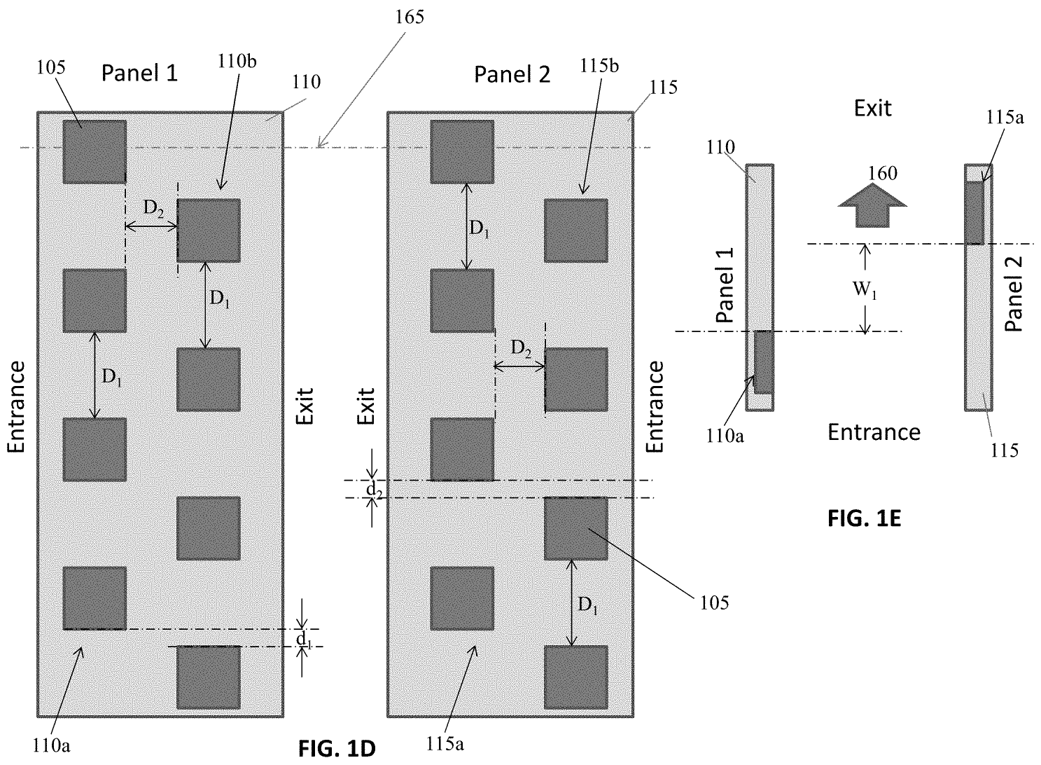

FIG. 1A is a schematic diagram of a detection system 100, in accordance with one embodiment of the present specification. The detection system 100 is typically used at an entrance to a public place, such as an airport, government building, public school, or amusement park as well as for ubiquitous sensing such as above doorframes, or at crosswalks. The detection system 100 is used to ensure safety for the public and can identify magnetic objects, referred to herein as “threat objects” on a person. In general, “threat objects” such as, but not limited to, guns, knives, bullets and other threatening objects can be classified as ferrous or ferromagnetic objects.

The detection system 100 comprises a plurality of magnetic field sensor modules 105 arranged in one or more arrays positioned on a first panel 110 and/or a second panel 115, in an embodiment. As illustrated, in one embodiment, the panels 110, 115 are configured vertically as a first side and a second side, wherein said first side 110 and said second side 115 are opposite one another and/or form parallel sides of a support frame 120 which defines an arch, portal or gate 125 defining a surveillance volume 130 through which a person can walk.

FIG. 1B illustrates a plurality of magnetic field sensor modules 105 arranged in the form of at least one array on each of two opposing sides of a support frame, in accordance with an embodiment of the present specification. Referring now to FIG. 1B, in some embodiments, the first panel 110 supports a plurality of magnetic field sensor modules 105 configured in the form of a first array 110a and a second array 110b while the second panel 115 supports a plurality of magnetic field sensor modules 105 configured in the form of a third array 115a and a fourth array 115b. In embodiments, the first and second arrays 110a, 110b as well as the third and fourth arrays 115a, 115b are arranged as parallel and vertical columns on the first and second panels 110, 115 of the support frame 120.

In alternate embodiments, only one of the first and second panels 110, 115 supports the magnetic field sensor modules 105 in the form of one or more arrays. For example, as shown in FIG. 1C, in some embodiments, only the first panel 110 of the support frame 120 includes first 110a and second array 110b. In still other embodiments, either both or any one of the two panels 110, 115 includes a single array of magnetic field sensor modules 105. In yet other embodiments, either both or any one of the two panels 110, 115 includes more than two arrays of magnetic field sensor modules 105. In yet other embodiments, the number of arrays may be equal on both panels 110, 115 while in alternate embodiments, the number of arrays may be unequal on the panels 110, 115.

In various embodiments, each of the arrays on the first and/or second panels 110, 115 includes at least four magnetic field sensor modules 105. In some embodiments, the number of magnetic field sensor modules 105 in each of the arrays on the first and/or second panels 110, 115 varies from one to four. Also, in various embodiments, the number of magnetic field sensor modules 105 may be equal or unequal amongst the arrays on the first and/or second panels 110, 115.

FIG. 1D is a plan view while FIG. 1E is a sectional top view of the first and second panels 110, 115. As shown in FIG. 1D, the first panel 110 supports first and second arrays 110a, 110b while the second panel 115 also supports third and fourth arrays 115a, 115b of magnetic sensor modules 105. In an embodiment, each of the arrays 110a, 110b, 115a, 115b includes four magnetic sensor modules 105. In accordance with an aspect of the present specification, the first and second arrays 110a, 110b are staggered, with respect to each other, vertically by a distance D₁ and horizontally by a distance D₂ on the panel 110. Similarly, the third and fourth arrays 115a, 115b are also staggered, with respect to each other, vertically by a distance D₁ and horizontally by a distance D₂ on the panel 115.

In embodiments, the distances D₁ and D₂ are equal or unequal. In some embodiments, D₁ is in a range of 10 mm to 800 mm and more specifically in the range of 20 mm to 400 mm. In some embodiments, D₁ is in a range of 10 mm to 800 mm and more specifically in the range of 20 mm to 400 mm. In some embodiments, D₂ is in a range of 10 mm to 800 mm and more specifically in the range of 20 mm to 400 mm.

As shown in FIG. 1E, in accordance with another aspect of the present specification, the arrays 110a, 110b on the first panel 110 are offset by a distance, in a horizontal or walkthrough direction 160, with respect to the arrays 115a, 115b, respectively, on the second panel 115. Since, FIG. 1E is a top view of the panels 110, 115 of FIG. 1D sectioned across a plane 165, only the first array 110a of the first panel 110 and the third array 115a of the second panel 115 are viewable in FIG. 1E as being offset by a distance W₁ in the walkthrough direction 160. It should be understood that the second array 110b on the first panel 110 and the fourth array 115b on the second panel 115 are also offset from one another by a distance W₂ (not visible in FIG. 1E) in a horizontal or walkthrough direction 160. In various embodiments, the offset distances W₁ and W₂ may be equal or unequal. In some embodiments, W₁, which is a distance from an edge of the first array of magnetic sensor modules 110a in one panel to an edge of the second array of magnetic sensor modules 115a in the opposing panel is in a range of 100 mm to 800 mm. In some embodiments, W₂, which is a distance from an edge of the second array of magnetic sensor modules 110a in one panel to an edge of the first array of magnetic sensor modules 115a in the opposing panel is in a range of 100 mm to 800 mm.

It should be appreciated that having two arrays (110a, 110b and 115a, 115b), in each panel (110, 115), staggered vertically with respect to one another enables localization in a top-to-bottom direction on a person walking through, while having the two arrays (110a, 110b) in one panel (110) offset with respect to the two arrays (115a, 115b) on the second panel (115), in the walkthrough direction (160), helps to identify front-to-back location on the person.

In some embodiments, as shown in FIG. 1D, the individual magnetic field sensor modules 105 are spaced equally from one another within an array, vertically, by a distance D₁ ranging from 20 cm to 80 cm. However, in alternate embodiments, the magnetic field sensor modules may be randomly or quasi-randomly spaced from one another. In some embodiments, two adjacent arrays (in embodiments where at least two arrays are arranged on a single side or panel of the frame 120) within the same panel, such as arrays 110a, 110b on panel 110 and arrays 115a, 115b on panel 115, are spaced from one another, in a horizontal, walkthrough direction of the person being inspected, by a distance D₂ ranging from 20 cm to 80 cm and preferably 50 cm. However, in alternate embodiments, the spacing between the two adjacent arrays may be random or quasi-random to minimize structured artifacts. In a preferred embodiment, having two arrays (110a, 110b and/or 115a, 115b) arranged vertically on either one or both of the panels 110, 115 enables improved spatial resolution in walkthrough direction as well as pedestrian height or vertical direction.

Referring again to FIG. 1A, in accordance with aspects of the present specification, the magnetic sensor modules 105 sense or detect perturbations, disturbances or changes in uniform magnetic fields, for example, the magnetic field of the earth caused by the presence of one or more ferromagnetic objects in the surveillance volume 130. Consequently, the first and/or second panels 110, 115 enable detection, localization and characterization of ferromagnetic objects present on the person walking through the surveillance volume 130.

Accordingly, a control system 135 is arranged to measure signals generated in each of the magnetic sensor modules 105 due to perturbations in the earth's magnetic field in the form of electrical currents or voltage. In some embodiments, the control system 135 comprises data acquisition and conditioning electronics 140 and a processing system 145, which, in one embodiment, is a host computer. The processing system 145 is in communication with a GUI (Graphical User Interface) screen 147 to display images and results of a scan to an operator. The data acquisition and conditioning electronics 140 collects data from the magnetic sensor modules 105 and the processing system 145 processes the collected conditioned signals to generate images and executes instructions to perform detection, characterization, and localization methods. In various embodiments, the data acquisition and conditioning electronics 140 performs a plurality of functions such as, but not limited to, data acquisition, normalization, background offset removal, filtering and serial data transmission to the processing system 145. In one embodiment, the detection system 100 also comprises camera 150 and camera 155 to generate images of the surveillance volume 130.

In accordance with an aspect of the present specification, the detection system 100 has the ability to detect and locate the position of a metal or ferrous object in three dimensions and is capable of quantifying the magnetic signature of a metal object in order to characterize and classify the metal object. The magnetic signature of a metal object is a function of a plurality of parameters or characteristics of the metal object such as, but not limited to, shape, electrical conductivity, magnetic permeability, magnetic polarisability tensor/magnetic polarisability dyadic and orientation.

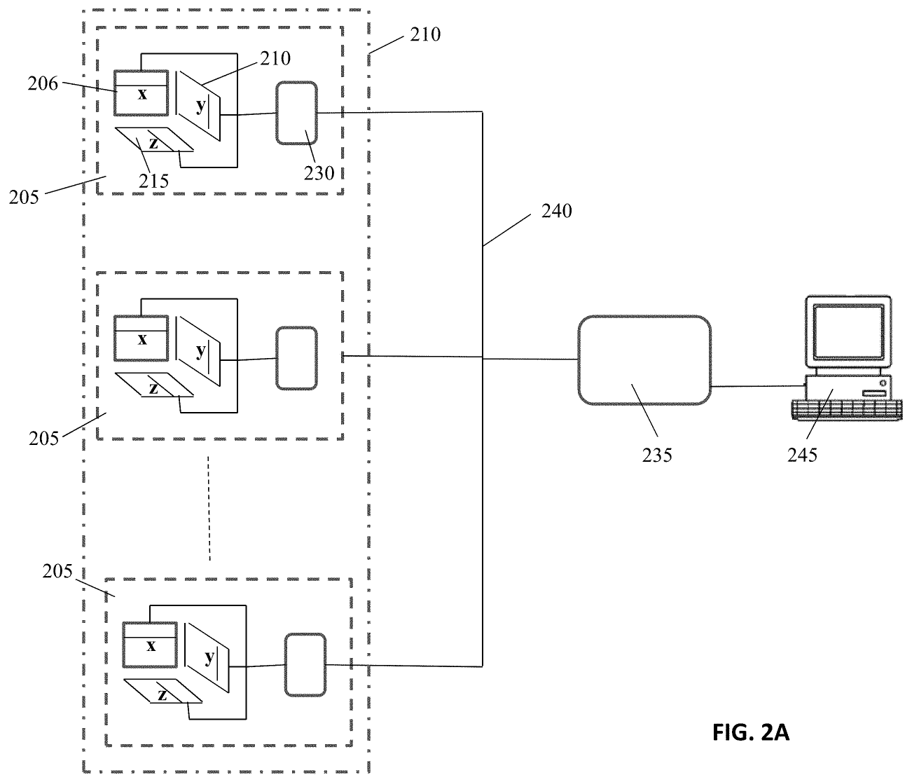

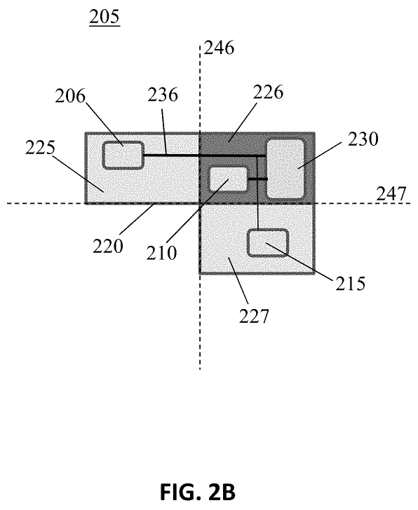

FIG. 2A illustrates a plurality of magnetic sensor modules 205 arranged in an array 210. As shown in FIG. 2A, in accordance with embodiments of the present specification, each of the magnetic sensor modules 205 includes first, second and third single-axis magnetometers 206, 210, 215 arranged to have their respective axis in substantially orthogonal directions x, y and z when the respective electronic circuit boards 220 (FIG. 2B) of each of the magnetic sensor modules 205 are in folded configuration. In various embodiments, the magnetometers may be Superconductivity Quantum Interfering Devices (SQUID), Anisotropic Magnetoresistive (AMR) or Giant Magnetoresistive (GMR) sensors, Fluxgate sensors (for example, Texas Instruments part number DRV425) or spin tunneling devices. The output signals from each of the magnetic sensor modules 205 are communicated to a control system 235 (similar to the control system 135 of FIG. 1) over an intra-array bus 240, and from the control system 235 to a processing system 245 (similar to the processing system 145 of FIG. 1A).

FIG. 2B is a block diagram illustration of a flexible electronic circuit board 220, of an individual magnetic sensor module 205, in a flat or unfolded configuration in accordance with an embodiment of the present specification. Referring to both FIGS. 2A and 2B, in one embodiment, the circuit board 220 is substantially L-shaped defining a first region 225 to carry a first magnetometer 206, a second region 226 to carry a second magnetometer 210 and a third region 227 to carry a third magnetometer 215. In one embodiment, the circuit board 220 also includes an on-board microcontroller or microprocessor 230 (FIG. 2A, 2B), such as a digital signal processor (DSP), to communicate with the three magnetometers 206, 210, 215 using an intra-module bus 236. The microprocessor 230 also communicates with the control system 235 over the intra-array bus 240. Alternatively, the control system 235 may be in direct communication with the three magnetometers 206, 210, 215 obviating a need for the on-board microprocessor 230. In some embodiments, the microprocessor 230 performs a plurality of functions such as, but not limited to, data acquisition, normalization, background offset removal, filtering and serial data transmission directly to the processing system 245, thereby obviating a need for the control system 235.

In accordance with an aspect of the present specification, the first and second regions 225, 226 when folded along first and second axes 246, 247 enable the three single-axis magnetometers 206, 210, 215 arranged to have their respective axes in substantially orthogonal directions x, y and z.

Thus, when a ferrous object passes within a sensing or scanning region of the three substantially orthogonally arranged magnetometers 206, 210, 215, the magnetic field of the ferrous object disturbs or changes the uniform magnetic field of the earth. The three magnetometers measure this change as a gradient in the magnetic field and respectively output a signal which is representative of characteristics of this gradient of the magnetic field in each of the three substantially orthogonal directions. The output signal, for example, analog signal such as a voltage or electric current, indicates the presence of a ferrous object within the scanning region, and therefore, enables detection, localization and characterization of the ferrous object.

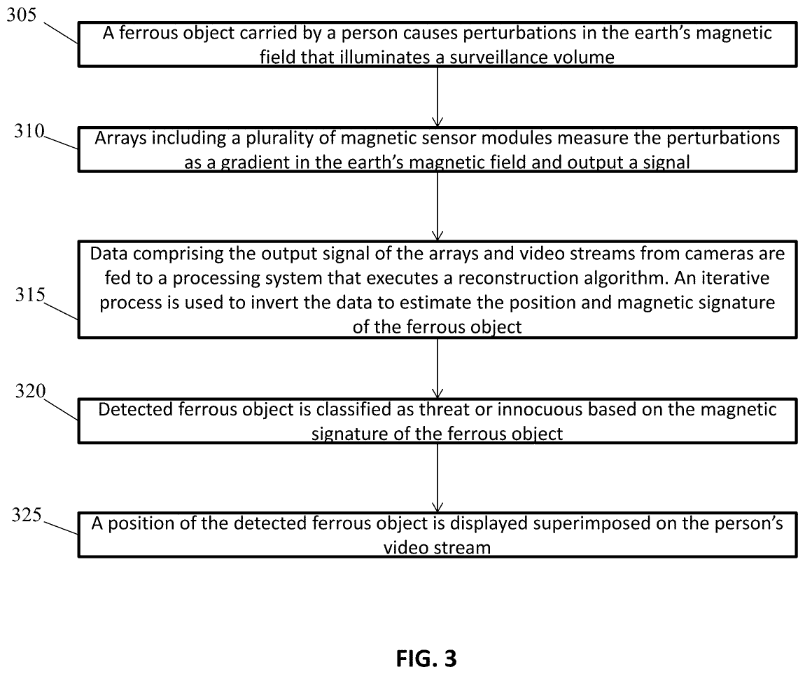

FIG. 3 is a flow chart illustrating a plurality of steps in accordance with an embodiment of a method of detection, localization and characterization of a ferrous object carried by a person walking through a surveillance volume of the detection system 100 of FIG. 1A.

Referring now to FIGS. 1A, 1B, 1C and FIG. 3 together, at step 305 the person carrying the ferrous object walks through the surveillance volume 130 as a result of which the ferrous object causes perturbations, disturbances or changes in the earth's magnetic field that illuminates the surveillance volume 130. At step 310, the plurality of magnetic sensor modules 105, arranged as arrays on first and/or second panels 110, 115 for example, measure the perturbations, disturbances or changes as a gradient in the earth's magnetic field and respectively output a signal (“output signal”) which is representative of at least a location/position and characteristics of this gradient of the magnetic field in each of the three substantially orthogonal directions—corresponding to the three single-axis magnetometers of each of the plurality of magnetic sensor modules 105.

At step 315, video image signals received from at least the video cameras 150, 155 and the output signals received from the arrays of the first and/or second panels 110, 115 are fed to the processing system 145 executing reconstruction instructions to estimate the position and the magnetic signature (for example, the magnetic polarisability tensor or magnetic polarisability dyadic) of the ferrous object by using the data collected from the object as it travels through the surveillance volume 130 of the detection system 100. In an embodiment, the reconstruction instructions are written in MATLAB. In other embodiments, the algorithm may be coded in any suitable programming language.

It should be appreciated that the output signals for the detected ferrous object may be a characteristic of the detected ferrous object together with a sequence of coordinate points or other suitable parameters that describe the path that the object has traveled either through or across the surveillance volume 130 of the detection system 100. In an embodiment, a complex magnetic polarisability dyadic tensor is used to suitably characterize the object. A magnetic polarisability dyadic tensor describes the three-dimensional scattering effect of the object to the earth's magnetic field. The polarisability tensor of the object when referred to the frame of reference given by its principal axes is a unique property of that object and can be used to classify or identify it. In embodiments, the processing system 145 calculates eigenvalues of the magnetic polarisability dyadic tensor for the object. In various other embodiments, other similar characteristics of detected objects may be used, and thus, the present application is not limited to the representation described herein.

Persons of ordinary skill in the art should appreciate that the output signals from the arrays of the first and/or second panels 110, 115 are time varying and change as one or more metal objects pass through the surveillance volume 130. Each measurement signal is sampled at a rate of 100 samples per second, which gives adequate temporal resolution for objects passing through the volume 130 at walking speed or less. Consequently there are 100 sample instants per second for each measurement signal in an exemplary embodiment of the present specification.

For every sample instant, the x, y, and z coordinates that indicate the location and the magnetic signature of the object being scanned, are calculated using the reconstruction process. Since the measurement signals consist of a sequence of samples (100 per second in this example), then a sequence of x, y, and z coordinates are calculated by the reconstruction process together with an estimation of the magnetic signature of the ferrous object. If there is more than one ferrous object then the reconstruction algorithm can be extended to calculate multiple x, y, and z coordinate sequences and multiple magnetic signatures, with one x, y, and z sequence and one signature per object.

In one embodiment, an iterative process is used to invert data (output signal of the arrays of the first and/or second panels 110, 115) where the position and properties of the ferrous object are estimated simultaneously by minimizing a residual between the measured data and a calculated data produced by a solution to the forward problem. The forward problem refers to the process of calculating the estimated values of the measurement signals, if the position and magnetic signature (such as, magnetic polarisability dyadic or magnetic polarisability tensor) of the ferrous object are known. The residual represents the square of the error between the estimated measurement signals and the actual measurement signals. When the residual is zero, there is no error between the estimated and actual measured signals and therefore the x, y, and z positions and magnetic signature for the ferrous object is calculated exactly.

Thus, in various embodiments, the processing system 145 executes a multi-parameter fitting algorithm (based on least-squares fitting) on the fed output signals (that is, the magnetic field gradient signals) from the arrays of the first and/or second panels 110, 115 to yield a three-dimensional position of the metal and its magnetic signature. The principle of multi-parameter fitting is that a mathematical model of the target is programmed into the algorithm. The algorithm selects an arbitrary starting position, strength and orientation for the “model” dipole and calculates the expected gradients and fields at the plurality of magnetic sensor modules. These are then compared with the actual measured gradients and fields. The position and magnetic signature of the model are then adjusted incrementally to find the best fit to the real data by a least-squares-fit method. The position and magnetic signature of the model is the best estimate of the real properties of the target metal. A method used to invert the output signals (that is, the magnetic field gradient signals) from the arrays of the first and/or second panels 110, 115 to yield a three-dimensional position of the metal and its magnetic signature, such as the magnetic polarisability dyadic tensor, is described in U.S. Pat. No. 9,562,986 titled “Walk through metal detection system” which is incorporated herein by reference.

At step 320, the detection system 100 generates an alarm based on one or more parameters, such as the location/position and/or the magnetic signature determined in step 315, in the characteristic data for the object. A classification method is applied to the characteristic data for this purpose. The classification method is used to determine which category the object belongs to, for example, either a threat object or an innocuous object. If any detected object falls in the threat category, an alarm is activated. As is evident to those of ordinary skill in the art, various other object categories could be defined and used for particular classification purposes.

At step 325, the processing system 145 combines the video streams from the cameras 150, 155 with the position of the ferrous object carried by the person to display (on screen 147) an image or video stream of the person overlaid with the position of the ferrous object.

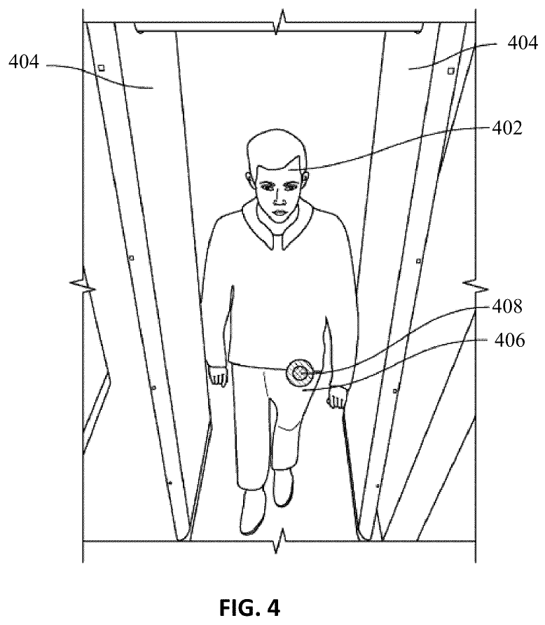

FIG. 4 illustrates an exemplary visual output of the detection system, in accordance with an embodiment of the present specification. Here the position of a ferrous object is superimposed upon a person 402 walking through a portal 404 of the detection system of the present specification. In this case the person 402 is carrying a ferritic steel penknife in the left trouser pocket 406 with the blade pointing in a vertical direction. As can be seen in FIG. 4, the reconstruction process has located the position of the knife as shown by circles 408 superimposed on the image of the person 402. In an embodiment, the circles 408 may be used to track the location of the metal object on a video stream of the person 402 walking through the portal 404.

It should be appreciated that in some embodiments, steps 320 and 325 may occur simultaneously while in other embodiments an order of these steps may be reversed. Depending upon whether the ferrous object is determined to be a threat at step 320 and based on the person's visuals, an operator may take appropriate actions.

The above examples are merely illustrative of the many applications of the methods and systems of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

1. A portal for scanning a person walking through a surveillance volume defined by said portal, wherein the surveillance volume is illuminated by a magnetic field, and wherein the person is carrying at least one object on the person's body, the portal comprising:
a plurality of magnetic sensor modules arranged in at least one array and positioned on at least one of first and second opposing sides of the portal, wherein said plurality of magnetic sensor modules measure perturbations in the magnetic field caused by said at least one object in the surveillance volume, and wherein each of said magnetic sensor modules includes first, second and third magnetometers configured in substantially three orthogonal directions; and
a processor associated with said plurality of magnetic sensor modules to process said measured perturbations to determine a location and magnetic signature of said at least one object.

2. The portal of claim 1, wherein said magnetic field is earth's magnetic field.

3. The portal of claim 1, wherein a first array is positioned on said first side and a second array is positioned on said second side.

4. The portal of claim 3, wherein each of said first and second arrays includes four magnetic sensor modules.

5. The portal of claim 1, wherein a first and a second array is positioned on said first side and a third and a fourth array is positioned on said second side.

6. The portal of claim 5, wherein each of said first, second, third, and fourth arrays includes four magnetic sensor modules.

7. The portal of claim 5 wherein said first and second array are staggered vertically by a predefined distance.

8. The portal of claim 5 wherein said third and fourth array are staggered vertically by a predefined distance.

9. The portal of claim 7 wherein said predefined distance is equal to half of a distance between each magnetic sensor module within the arrays.

10. The portal of claim 5 wherein said first and second array on said first panel are offset by a predetermined distance in a horizontal or walkthrough direction with respect to said third and fourth arrays on said second panel.

11. The portal of claim 1, wherein said measured perturbations represent a gradient of the magnetic field in each of said substantially three orthogonal directions.

12. The portal of claim 1, wherein each of said first, second and third magnetometers are single-axis magnetometers.

13. The portal of claim 1, wherein each of said plurality of magnetic sensor modules includes a substantially L-shaped flexible circuit board when flat, said circuit board defining a first region to carry the first magnetometer, a second region to carry the second magnetometer and a third region to carry the third magnetometer, wherein folding of said circuit board arranges said magnetometers in substantially three orthogonal directions.

14. The portal of claim 1, wherein each of said plurality of magnetic sensor modules has an associated Digital Signal Processor (DSP) to acquire and condition said perturbations of the magnetic field.

15. The portal of claim 1, wherein said magnetic signature is a magnetic polarizability tensor of said at least one object.

16. A method for scanning a person walking through a surveillance volume defined by a portal, wherein the surveillance volume is illuminated by a magnetic field, and wherein the person is carrying at least one object on the person's body, the method comprising:
using a plurality of magnetic sensor modules to measure perturbations in the magnetic field caused by said at least one object in the surveillance volume, wherein said plurality of magnetic sensor modules are arranged in at least one array and positioned on at least one of first and second opposing sides of the portal, and wherein each of said magnetic sensor modules includes first, second and third magnetometers configured in substantially three orthogonal directions; and
processing said measured perturbations to determine a location and magnetic signature of said at least one object.

17. The method of claim 16, wherein said magnetic field is earth's magnetic field.

18. The method of claim 16, wherein a first array is positioned on said first side and a second array is positioned on said second side.

19. The method of claim 18, wherein each of said first and second arrays includes four magnetic sensor modules.

20. The method of claim 16, wherein said measured perturbations represent a gradient of the magnetic field in each of said substantially three orthogonal directions.

21. The method of claim 16, wherein each of said first, second and third magnetometers are single-axis magnetometers.

22. The method of claim 16, wherein each of said plurality of magnetic sensor modules includes a substantially L-shaped flexible circuit board when flat, said circuit board defining a first region to carry the first magnetometer, a second region to carry the second magnetometer and a third region to carry the third magnetometer, wherein folding of said circuit board arranges said magnetometers in substantially three orthogonal directions.

23. The method of claim 16, wherein each of said plurality of magnetic sensor modules has an associated DSP to acquire and condition said perturbations of the magnetic field.

24. The method of claim 16, wherein said magnetic signature is a magnetic polarizability tensor of said at least one object.

25. A portal for scanning a person walking through a surveillance volume defined by said portal, wherein the surveillance volume is illuminated by a magnetic field, and wherein the person is carrying at least one object on the person's body, the portal comprising:
a plurality of magnetic sensor modules arranged in at least one array and positioned on at least one of first and second opposing sides of the portal, wherein said plurality of magnetic sensor modules measure perturbations in the magnetic field caused by said at least one object in the surveillance volume, wherein each of said magnetic sensor modules includes a flexible circuit board defining a first region to carry a first magnetometer, a second region to carry a second magnetometer and a third region to carry a third magnetometer, said circuit board being substantially L-shaped when flat, and wherein folding of said circuit board arranges said first, second and third magnetometers in substantially three orthogonal directions; and
a processor associated with said plurality of magnetic sensor modules to process said measured perturbations to determine a location and magnetic signature of said at least one object.

26. The portal of claim 25, wherein said magnetic signature is a magnetic polarizability tensor of said at least one object.

27. The portal of claim 8 wherein said predefined distance is equal to half of a distance between each magnetic sensor module within the arrays.
